(19) United States
(12) Patent Application Publication
(10) Pub. No.: US 2015/0206399 A1
(43) Pub. Date: Jul. 23, 2015

(54) BACCARAT GAME WITH ASSOCIATED WAGERING GAME

(71) Applicant: Vegas Game Point, LLC, Las Vegas, NV (US)

(72) Inventor: Timothy J. Shelburn, Las Vegas, NV (US)

(21) Appl. No.: 14/462,491

(22) Filed: Aug. 18, 2014

Related U.S. Application Data
(60) Provisional application No. 61/866,919, filed on Aug. 16, 2013.

(51) Int. Cl. G07F 17/32; A63F 1/00

(52) U.S. Cl. CPC G07F 17/3293; A63F 1/00; G07F 17/3244; A63F 2001/001

(57) ABSTRACT

System and methods for administering wagering games that are associated with the game of Baccarat, which include wagers that are resolved by comparing the resulting numerical hand score after an additional card is dealt according to the rules of Baccarat to at least one of the player hand and/or the banker hand, and providing an award if the resulting numerical hand score is either less than the initial hand score, the same as the initial hand score, or both.

### CROSS-REFERENCE TO RELATED APPLICATION

This application claims priority to U.S. Provisional Patent Application Ser. No. 61/866,919 filed Aug. 16, 2013, the disclosure of which is incorporated herein in its entirety by this reference.

### FIELD OF THE INVENTION

The invention relates generally to systems and methods of modifying, providing and conducting wagering games, and more particularly, to systems and methods of modifying, providing and conducting the game of Baccarat.

### BACKGROUND OF THE INVENTION

Baccarat is a popular game that is oftentimes played in casino environments. It may take the form of a card table game, played with a shoe of cards that is typically an aggregation of several decks of physical playing cards, or it can be simulated as an electronic table game or an online game.

The most commonly known form of Baccarat is traditional Baccarat, also known as punto banco, North American Baccarat, tableau Baccarat or mini-Baccarat, which are games of chance. Other forms of Baccarat are Baccarat chemin de fer and baccarat banque, which involve player skill in addition to an element of chance. The wagering outcomes in traditional Baccarat are typically those of the “Player” hand winning, the “Banker” hand winning or neither of the said hands winning, thereby resulting in a so-called “Tie”, wherein tie bets win. Those skilled in the art of gaming will understand the rules according to which cards or their electronic representations are dealt to gaming participants and the banker in each hand of Baccarat, and such skilled persons will also appreciate the various house rules according to which the winning wagers that are placed on the foregoing wagering outcomes are typically paid or allocated as between those gaming participants and the house.

For example, if the initial player hand of two cards totals a numerical hand score of 6 or more, then the player must stand without drawing a card. If the player hand totals 5 or less, the player hand will receive one additional card. If the initial banker hand of two cards totals a numerical hand score of 7 or more, then the banker hand must stand without drawing a card. If the banker hand of two cards totals 0, 1, or 2, then the banker hand must receive one card. If the banker's first two cards total 3, 4, 5, or 6, then whether the banker hand receives an additional card is determined by the whether the player hand drew an additional card, and if so the value of the player's drawn card, as shown by the table below.

| | Player's Third Card Value | | | | | | | | | |
|---|---|---|---|---|---|---|---|---|---|---|
| Banker's Hand Value | 0 | 1 | 2 | 3 | 4 | 5 | 6 | 7 | 8 | 9 |
| 0 | H | H | H | H | H | H | H | H | H | H |
| 1 | H | H | H | H | H | H | H | H | H | H |
| 2 | H | H | H | H | H | H | H | H | H | H |
| 3 | H | H | H | H | H | H | H | H | S | H |
| 4 | S | S | H | H | H | H | H | H | S | S |
| 5 | S | S | S | S | H | H | H | H | S | S |
| 6 | S | S | S | S | S | S | H | H | S | S |
| 7 | S | S | S | S | S | S | S | S | S | S |

*H indicates Hit,
S indicates Stand

While Baccarat is a very popular game, many new games which are quickly rising in popularity provide numerous wagering opportunities, thus increasing player participation and excitement. Consequently, further variations of existing wagering games are always of interest to players and casino operators, and therefore, there is a desire for systems and methods which would increase wagering in the game of Baccarat.

### SUMMARY OF THE INVENTION

Some embodiments of the invention are directed to a method of providing a wagering game associated with the game of Baccarat comprising the steps of: conducting the underlying game to form an initial player hand of two cards and an initial banker hand of two cards; determining the hand rank or relative value of the initial player hand and/or the initial banker hand; providing an opportunity to players to place additional wagers on any additional cards to be drawn to the initial player hand and/or the initial banker hand prior to the dealing thereof, wherein the wager may be resolved based on the composition of the one or more drawn cards and/or the resulting composition or score of the initial player hand and/or the initial banker hand; receiving one or more wagers; dealing the one or more additional cards to the initial player hand and/or the initial banker hand; resolving the one or more wagers by providing an award payout or collecting the wagers.

In some embodiments, the wager is resolved based on the suit or rank of the drawn card to either the initial player hand or the initial banker hand. In some embodiments, the wager is resolved based on the resulting composition of the initial player hand or the initial banker hand with the additional one or more cards, such as the appearance of a pair of cards or poker hand formed. In some embodiments, the wager is resolved based on the value of the card drawn according to the rules of Baccarat or the resulting score of the initial player hand or initial banker hand.

Some embodiments of the invention are directed to a method of administering an underlying game of Baccarat with an associated wagering game, comprising the steps of: a) responsive to the card drawing rules of Baccarat requiring the distribution of an additional physical playing card from a group of one or more standard 52-card decks of randomly-ordered physical playing cards to one of a player hand having an initial numerical hand score according to the rules of Baccarat and a banker hand having an initial numerical hand score according to the rules of Baccarat, receiving a wager from one or more players to participate in the associated wagering game, wherein the wager is received by positioning a physical wagering element having an assigned monetary value in at least one of a designated player hand associated wager area and a designated banker hand associated wager area defined on the surface of the gaming table prior to the distribution of the playing card; b) responsive to receiving the wager and distribution of an additional physical playing card to one of the player hand and banker hand, comparing the resulting numerical hand score according to the rules of Baccarat for at least one of the player hand and the banker hand with a preset criterion, wherein the preset criterion is the resulting numerical hand score being less than the initial hand score subsequent to the distribution of the additional physical playing card; and c) resolving the associated wagering game by one of i) a player win, wherein an award in the form of a physical wagering element having an assigned monetary value is distributed to the participating player responsive to the satisfaction of the preset criterion and ii) a player loss, wherein the physical wagering element is removed from the designated area responsive to the failure to satisfy the preset criterion.

In some embodiments, the aforementioned method further includes the steps of: distributing physical playing cards from the group of one or more standard 52-card decks of randomly-ordered physical playing cards to a player designated area and a banker designated area on the surface of the gaming table to form the player hand and the banker hand according to the rules of Baccarat; and determining the initial numerical hand score for the player hand and the banker hand.

In some embodiments, the aforementioned method further includes the steps of: distributing one or more additional physical playing cards from the group of one or more standard 52-card decks of randomly-ordered physical playing cards to one of a player designated area and a banker designated area on the surface of the gaming table to form one of the final player hand and the final banker hand according to the drawing rules of Baccarat; and determining the resulting numerical hand score for one of the player hand and the banker hand responsive to the distribution of the physical playing card.

In some embodiments, the preset criterion further comprises a preset criterion that the resulting numerical hand score is the same as the initial hand score subsequent to the distribution of the additional physical playing card.

In some embodiments, the amount of the award is determined at least partially by the initial hand score. In other embodiments, the amount of the award is determined by the resulting hand score. For example, the lower the resulting hand score, the greater the potential award may be.

Some embodiments of the invention are directed to a method of providing a wagering game associated with an underlying game of Baccarat through a electronic player terminal, comprising the steps of: a) receiving a wager through a data communication device from one or more players to participate in the associated wagering game responsive to displaying Baccarat game play information on a display device indicating that the card drawing rules of Baccarat require the addition of a randomly-generated playing card to one of a player hand having an initial numerical hand score according to the rules of Baccarat and a banker hand having an initial numerical hand score according to the rules of Baccarat; b) responsive to receiving the wager and the addition of a randomly-generated playing card to one of the player hand and banker hand, a processor facilitating the comparison of the resulting numerical hand score according to the rules of Baccarat for at least one of the player hand and the banker hand with a preset criterion, wherein the preset criterion is the resulting numerical hand score being less than the initial hand score subsequent to the addition of the randomly-generated playing card, and resolving the associated wagering game by one of i) a player win, wherein an award is distributed to the participating player responsive to the satisfaction of the preset criterion and ii) a player loss, wherein the wager is lost responsive to the failure to satisfy the preset criterion; and c) displaying an indication of the resolution of the associated wagering game on the display device.

In some embodiments, the addition of the randomly-generated playing cards comprises the distribution of an additional physical playing card from a group of one or more randomly-ordered standard 52-card decks of physical playing cards. In other embodiments, the addition of the randomly-generated playing cards is facilitated by a random number generator. The random number generator may produce random numbers which are then mapped to playing cards or symbols to simulate one or more randomly-ordered standard decks of playing cards.

In some embodiments, the invention is directed to a method of administering an underlying game of Baccarat with an associated wagering game, comprising the steps of: a) responsive to the card drawing rules of Baccarat requiring the distribution of an additional physical playing card from a group of one or more standard 52-card decks of randomly-ordered physical playing cards to one of a player hand having an initial numerical hand score according to the rules of Baccarat and a banker hand having an initial numerical hand score according to the rules of Baccarat, receiving a wager from one or more players to participate in the associated wagering game, wherein the wager is received by positioning a physical wagering element having an assigned monetary value in at least one of a designated player hand associated wager area and a designated banker hand associated wager area defined on the surface of the gaming table prior to the distribution of the playing card; b) responsive the receiving of the wager and the distribution of an additional physical playing card to one of the player hand and banker hand, comparing the resulting numerical hand score according to the rules of Baccarat for at least one of the player hand and the banker hand with at least one of a first preset criterion, wherein the first preset criterion is satisfied by the resulting numerical hand score being less than the initial hand score subsequent to the distribution of the additional physical playing card, and a second preset criterion, wherein the second preset criterion is satisfied by the resulting numerical hand score being equal to the initial hand score subsequent to the distribution of the additional physical playing card; and c) resolving the associated wagering game by one of i) a player win, wherein an award in the form of a physical wagering element having an assigned monetary value is distributed to the participating player responsive to the satisfaction of one of the preset criterion and ii) a player loss, wherein the physical wagering element is removed from the designated area responsive to the failure to satisfy the preset criterion.

In some embodiments, the amount of the award for satisfaction of the first and/or second preset criterion is determined by the initial hand score. In other embodiments, the amount of the award for satisfaction of the first preset criterion is determined by the resulting hand score.

In some embodiments, each of the designated player hand associated wager area and the designated banker hand associated wager area further comprise two areas defined on the surface of the gaming table, wherein the two areas include a first wagering area for receiving a wager relating to satisfaction of the first preset criterion and a second wagering area for receiving a wager relating to satisfaction of the second preset criterion.

In some embodiments, the aforementioned method further includes the steps of: distributing one or more additional physical playing cards from the group of one or more standard 52-card decks of randomly-ordered physical playing cards to one of a player designated area and a banker designated area on the surface of the gaming table to form one of the final player hand and the final banker hand according to the drawing rules of Baccarat; and determining the resulting numerical hand score for one of the player hand and the banker hand responsive to the distribution of the physical playing card.

Some embodiments of the invention are directed to systems for providing the above methods, which may include one or more data communication devices, display devices, and processing devices, which may be local or remote, as necessary to provide these methods on any computerized or partially computerized platforms, online or through a local or global communication network, including mobile devices, home computers, single or multiplayer electronic gaming machines enabling play with virtual or real currency and/or virtual or real playing cards, devices or kiosks for enabling wagering on the play of a live Baccarat game.

Some embodiments of the invention are also directed to a non-transitory machine readable media for providing a wagering game associated with an underlying game of Baccarat including one or more software programs, code and/or data segments as necessary to provide any of the methods described herein on one or more machines.

### BRIEF DESCRIPTION OF THE DRAWINGS

FIG. 1 is a process flow chart depicting an exemplary embodiment of the invention.

FIG. 2 is process flow chart depicting another exemplary embodiment of the invention.

FIG. 3 is a schematic diagram of an exemplary table layout configured for use with methods according to some embodiments of the invention, including physical or live table systems and virtual or partially virtual electronic platforms.

FIG. 4 is a schematic diagram of exemplary system components configured for use with methods according to some embodiments of the invention.

### DETAILED DESCRIPTION OF THE INVENTION

The invention is generally directed to systems, methods and apparatus for providing, operating, hosting and conducting wagering games for players associated with the game of Baccarat.

It should be understood that the words “wager,” “wagering,” “betting” or “bet,” or the like, refers to any type of points, money, credits, items of value, including physical or virtual representations thereof, which are placed at stake in that they may be forfeit depending on the occurrence of machine-generated randomly generated outcomes, such as outcomes which may be provided by revealing physical playing cards drawn from one or more decks or groups of randomly-ordered physical playing cards or a random number generator for randomly generating numbers which can be mapped to identify playing card results.

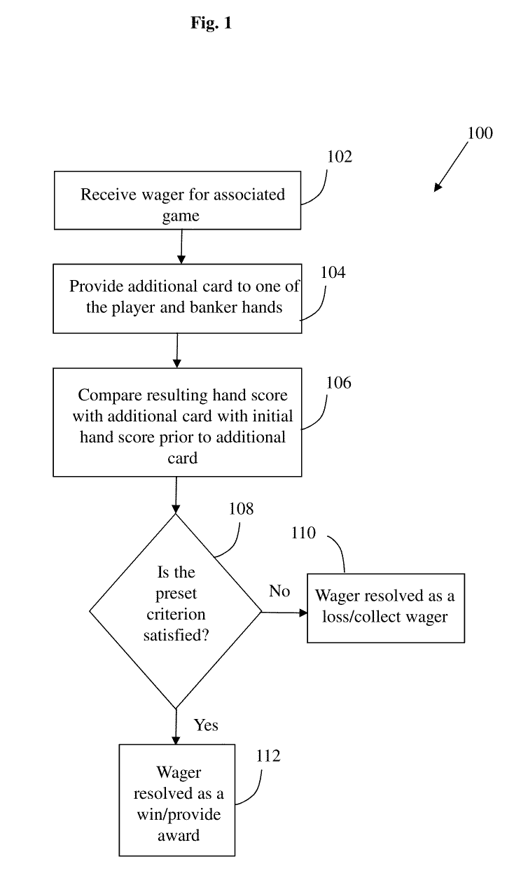

Referring to FIG. 1, a flowchart diagram of a method of administering a wagering game is shown and generally referred to as method 100. Method 100 includes a step 102 of receiving a wager from individual players to play a wagering game associated with the game of Baccarat. Step 102 presumes that the initial player and banker hands of two cards each have been formed and these hands are not natural winners, but rather, an additional card must be drawn for either one of the player and banker hands based on the initial numerical hand score and the rules of Baccarat. It should be understood that the playing cards may be distributed from a random group of playing cards, such as one or more randomly-ordered standard 52-card decks of cards held in a Baccarat shoe.

Step 102 may involve the positioning of physical elements which represent monetary amounts (e.g., tokens or chips) in a designated area at a physical gaming table having a surface with various designated wagering areas for placing wagers in the associated wagering game of the invention, either on the player or banker hand, or for both, depending on timing as the player hand is the first to be resolved. Thus, a wager may be received in step 102 on the player hand, and then again on the banker hand, if the rules of Baccarat require drawing an additional card to both the player hand and the banker hand.

At step 104, randomly-ordered physical cards are distributed to at least one of the player and banker hands. At step 106, the numerical hand score resulting from the addition of a card to either one of the player and banker hands, depending on which is wagered upon, is compared with the initial numerical score.

As shown by steps 108 and 110, if the preset criterion is not satisfied, that is, in this embodiment, if the resulting numerical hand score is not less than the initial numerical score, then the wager received in step 102 in the associated game is resolved as a loss and collected or removed from the designated area.

As shown by steps 108 and 112, if the preset criterion of the resulting numerical hand score being less than the initial hand score is satisfied, then the wager received in step 102 is resolved as a win and an award is provided to the player.

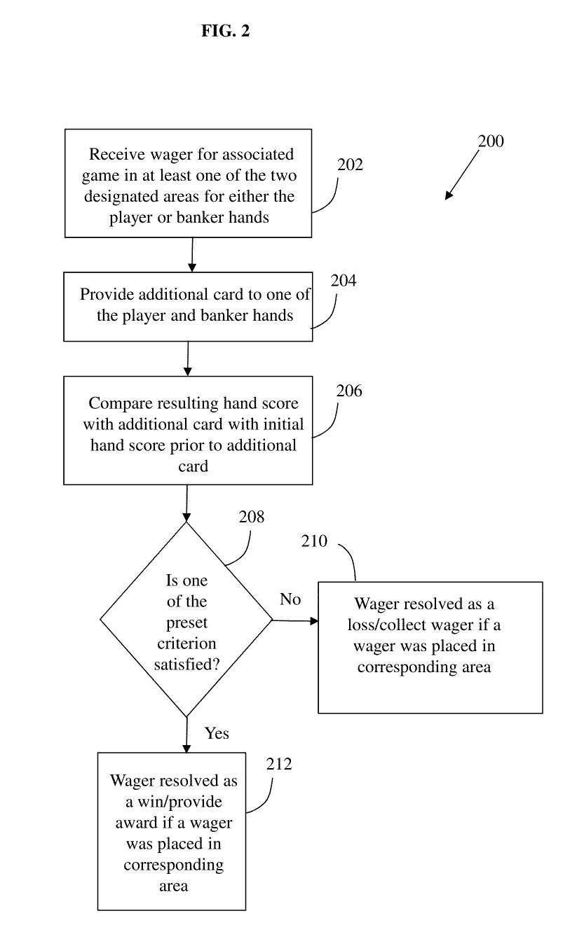

FIG. 2 shows a flow diagram for another embodiment of the invention which is generally referred to as method 200.

In method 200, a wager is received by the positioning of a physical game element in one of two designated areas. A first designated area corresponds to the satisfaction of a first preset criterion in step 208, wherein the first preset criterion is that the resulting hand score is less than the initial hand score subsequent to the addition of a playing card pursuant to the drawing rules of the Baccarat, as in method 100. A second designated area corresponds to the satisfaction of a second preset criterion in step 208, wherein the second preset criterion is that the hand score remains the same after the addition of a playing card pursuant to the drawing rules of the Baccarat. Thus, players may wager that either one or both of the player and banker hand scores will either stay the same or be decreased after drawing an additional card, if drawing a card is required for either one or both hand pursuant to the rules of Baccarat. Players may first place one or both wagers on a player hand, if the rules of Baccarat require drawing an additional card to the player hand, and thereafter on the banker hand if the rules of Baccarat set forth that an additional card must be drawn to the banker hand.

For example, if the player's total is 5 or less, then according to the rules of Baccarat the player hand will receive another card. Either hand will stand if it has an 8 or 9. If the player hand stands, then according to the rules of Baccarat the banker hand will receive another card if it has a total of 5 or less. Thus, players may wager in the associated game for both player and banker hands for the preset criterion in method 100 and both the first and second preset criterions in method 200.

The exemplary paytable below provides an exemplary embodiment of the invention in which the lower hand score of any hand resulting from the provision of an additional card increase the award payout. The paytable awards are expressed as multiples of the unit wager received for either player hand or banker hand satisfying the preset criterion of method 100 or the first preset criterion of method 200 is set forth below and based on the resulting hand score.

| Resulting | |
|---|---|
| hand score | Paytable |
| Drawing to 1 | 9:1 |
| Drawing to 2 | 5:1 |
| Drawing to 3 | 3:1 |
| Drawing to 4 | 2:1 |
| Drawing to 5 | 1:1 |
| Drawing to 6 | 1:1 |

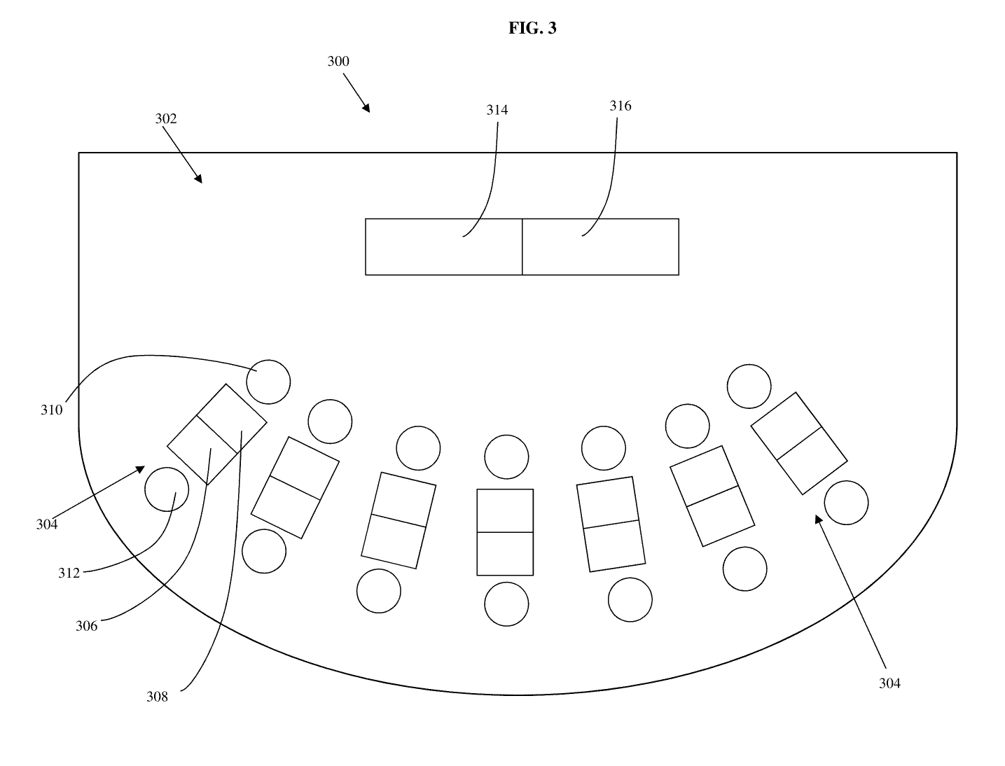

FIG. 3 illustrates a live or virtual gaming table display 300 configured for operating in accordance with embodiments of the invention. Display 300 includes a layout 302 for use in facilitating the presentment and display of a method of the invention such as method 200. Layout 302 may be a physical or virtual representation of a felt table display, as it should be understood that the methods of the invention would function as described herein if any one or more of the layout, cards, dealers or wagering chips or apparatus were virtually or physically represented. Layout 302 includes a multiple player positions or interfaces 304. Each player position 304 may include designated Baccarat wagering areas 306 and 308, for wagering in the underlying game of Baccarat, along with a designated first associated game wagering area 310 and a designated second associated game wagering area 312, for wagering on the first and second criterion of method 200 for both the player and banker hands. Layout 302 may further include a player hand designated area 314 and a banker hand designated area 316. It should be understood that layout 302 is a non-limiting example which may be modified in accordance with the invention and include additional areas and information.

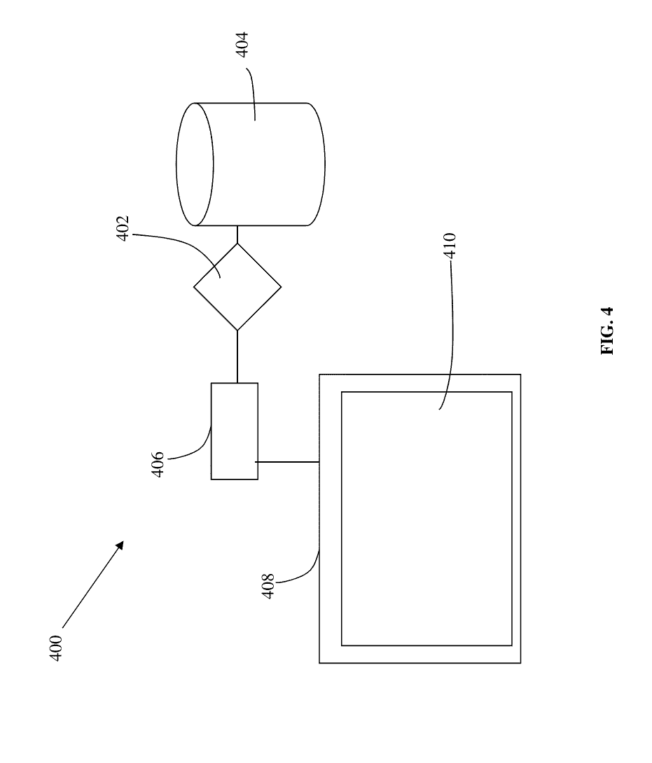

FIG. 4 illustrates an exemplary system 400 constructed in accordance with some embodiments of the invention. System 400 includes processing device 402 in communication with a database or memory device 404, data communication or data input/output device 406 and a display device 408. In some embodiments, display device 408 is a touch-enabled device and includes a data input device component. Memory device 404 may include data relating to the underlying game and embodiments of the invention as described herein, such as the preset bonus rankings. A single player position 410 or layout such as layout 302 may displayed on display device 408 along with virtual representations of game implements, such as cards and wagering elements. Game outcomes are displayed and wagers are tracked and resolved using display device 408 and processing device 402 for comparing the player and dealer hand scores with the preset criterion or criterions and determining the award amounts

Methods in accordance with embodiments of the disclosure may be administered online over the Internet, or otherwise through a global communication network, in one embodiment using a gaming system employing a client server architecture.

The wagering games supported by gaming systems of the invention, such as system 400, may be operated with real currency or with virtual credits or other virtual (e.g., electronic) value indicia. For example, the real currency option may be used with traditional casino and lottery-type wagering games in which money or other items of value are wagered and may be cashed out at the end of a game session. The virtual credits option may be used with wagering games in which credits (or other symbols) may be issued to a player to be used for the wagers. A player may be credited with credits in any way allowed including, but not limited to, a player purchasing credits, being awarded credits as part of a contest or a win event in this or another game (including non-wagering games), being awarded credits as a reward for use of a product, casino or other enterprise, time played in one session, games played, or may be as simple as virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well. An additional variation includes sites having both play-for-fun and wagering games, including issuance of free credits usable to play the play-for-fun games. This may attract players to the site and to the games before they engage in wagering. In some embodiments, a limited number of free or promotional credits may be issued to entice players to play the games. Another method of issuing credits includes free credits in exchange for identifying friends who may want to play. In another embodiment, additional credits may be issued after a period of time has elapsed to encourage the player to resume playing the game. The gaming system 400 may enable players to buy additional game credits to allow the player to resume play. Objects of value may be awarded to play-for-fun players, which may or may not be in a direct exchange for credits. For example, a prize may be awarded or won for a highest scoring play-for-fun player during a defined time interval. All variations of credit redemption are contemplated, as desired by game designers and game hosts (the person or entity controlling the hosting systems).

Gaming systems of the invention may include various gaming platforms, such as those that establish a portal for an end user to access a wagering game hosted by a game server through a user interaction server. Players may use devices, such as mobile phones, to communicate with the user interaction server of the gaming system over a network such as the Internet. The user interaction server may communicate with the game server, which may function as a game engine, and provide game information to the user through the user's device so that, for example, the user may receive an opportunity to place a wager which would be communicated through the user device. The user interaction server may also provide a client on the user device for accessing the gaming system of the invention. In some embodiments, the client is a script driver including scripting language that controls an interface. The script driver may include simple function calls requesting information from the gaming system. In other embodiments, the client comprises an executable program rather than a script.

A network may enable communications between the user device and the gaming system and may therefore include links using technologies such as Ethernet, 802.11, worldwide interoperability for microwave access (WiMAX), 3G, digital subscriber line (DSL), asynchronous transfer mode (ATM), InfiniB and, PCI Express Advanced Switching, etc., and include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc.

It should be understood that an electronic gaming system of the invention may include at least one processor coupled to a chipset, memory, a data storage device, a data communication device or player interface, a graphics adapter, and a network adapter. The data communication device may include a display device which is coupled to the graphics adapter. The data storage device may be any non-transitory computer-readable storage medium, such as a hard drive, compact disc read-only memory (CD-ROM), DVD, or a solid-state memory device (e.g., a flash drive). The memory holds instructions and data used by the processor. The graphics adapter displays images and other information on the display device. The network adapter couples the gaming system to a local or wide area network, such as a back-end system at a casino.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations or transformation of physical quantities or representations of physical quantities as modules or code devices, without loss of generality.

Those skilled in the art will readily appreciate that the methods described herein may be incorporated in a system in accordance with the invention using virtual representations of game table layouts. The system of the invention may include various computer and network related software and hardware, such as programs, operating systems, memory storage devices, data input/output devices, data processors, servers with links to data communication systems, wireless or otherwise, and data transceiving terminals, and may be a standalone device or incorporated in another platform, such as a mobile device. The system of the invention may be provided on electronic platforms with multiple player positions. In addition, the system of the invention may be provided at least in part on a personal computing device, such as home computer, laptop or mobile computing device through an online communication connection or connection with the Internet. Those skilled in the art will further appreciate that the precise types of software and hardware used are not vital to the full implementation of the methods of the invention so long as players and operators thereof are provided with useful access thereto or the opportunity to play the game as described herein.

While exemplary systems and methods, and applications of methods of the invention, have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting of the scope of the invention in any way. Accordingly, the invention embraces alternatives, modifications and variations which fall within the spirit and scope of the invention and claims as set forth herein and equivalents thereto.

What is claimed is:

1. A method of administering an underlying game of Baccarat with an associated wagering game, comprising the steps of:
a) responsive to the card drawing rules of Baccarat requiring the distribution of an additional physical playing card from a group of one or more standard 52-card decks of randomly-ordered physical playing cards to one of a player hand having an initial numerical hand score according to the rules of Baccarat and a banker hand having an initial numerical hand score according to the rules of Baccarat, receiving a wager from one or more players to participate in the associated wagering game, wherein the wager is received by positioning a physical wagering element having an assigned monetary value in at least one of a designated player hand associated wager area and a designated banker hand associated wager area defined on the surface of the gaming table prior to the distribution of the playing card;
b) responsive to receiving the wager and distribution of an additional physical playing card to one of the player hand and banker hand, comparing the resulting numerical hand score according to the rules of Baccarat for at least one of the player hand and the banker hand with a preset criterion, wherein the preset criterion is the resulting numerical hand score being less than the initial hand score subsequent to the distribution of the additional physical playing card; and
c) resolving the associated wagering game by one of i) a player win, wherein an award in the form of a physical wagering element having an assigned monetary value is distributed to the participating player responsive to the satisfaction of the preset criterion and ii) a player loss, wherein the physical wagering element is removed from the designated area responsive to the failure to satisfy the preset criterion.

2. A method according to claim 1, further comprising the steps of:
distributing physical playing cards from the group of one or more standard 52-card decks of randomly-ordered physical playing cards to a player designated area and a banker designated area on the surface of the gaming table to form the player hand and the banker hand according to the rules of Baccarat; and
determining the initial numerical hand score for the player hand and the banker hand.

3. A method according to claim 1, further comprising the steps of:
distributing one or more additional physical playing cards from the group of one or more standard 52-card decks of randomly-ordered physical playing cards to one of a player designated area and a banker designated area on the surface of the gaming table to form one of the final player hand and the final banker hand according to the drawing rules of Baccarat; and
determining the resulting numerical hand score for one of the player hand and the banker hand responsive to the distribution of the physical playing card.

4. A method according to claim 1, wherein the preset criterion further comprises a preset criterion that the resulting numerical hand score is the same as the initial hand score subsequent to the distribution of the additional physical playing card.

5. A method according to claim 1, wherein the amount of the award is determined by the resulting numerical hand score.

6. A method of providing a wagering game associated with an underlying game of Baccarat through a electronic player terminal, comprising the steps of:
a) receiving a wager through a data communication device from one or more players to participate in the associated wagering game responsive to displaying Baccarat game play information on a display device indicating that the card drawing rules of Baccarat require the addition of a randomly-generated playing card to one of a player hand having an initial numerical hand score according to the rules of Baccarat and a banker hand having an initial numerical hand score according to the rules of Baccarat;
b) responsive to receiving the wager and the addition of a randomly-generated playing card to one of the player hand and banker hand, a processor facilitating the comparison of the resulting numerical hand score according to the rules of Baccarat for at least one of the player hand and the banker hand with a preset criterion, wherein the preset criterion is the resulting numerical hand score being less than the initial hand score subsequent to the addition of the randomly-generated playing card, and resolving the associated wagering game by one of i) a player win, wherein an award is distributed to the participating player responsive to the satisfaction of the preset criterion and ii) a player loss, wherein the wager is lost responsive to the failure to satisfy the preset criterion; and
c) displaying an indication of the resolution of the associated wagering game on the display device.

7. A method according to claim 6, wherein the addition of the randomly-generated playing cards comprises the distribution of an additional physical playing card from a group of one or more randomly-ordered standard 52-card decks of physical playing cards.

8. A method according to claim 6, wherein the addition of the randomly-generated playing cards is facilitated by a random number generator.

9. A method of administering an underlying game of Baccarat with an associated wagering game, comprising the steps of:
a) responsive to the card drawing rules of Baccarat requiring the distribution of an additional physical playing card from a group of one or more standard 52-card decks of randomly-ordered physical playing cards to one of a player hand having an initial numerical hand score according to the rules of Baccarat and a banker hand having an initial numerical hand score according to the rules of Baccarat, receiving a wager from one or more players to participate in the associated wagering game, wherein the wager is received by positioning a physical wagering element having an assigned monetary value in at least one of a designated player hand associated wager area and a designated banker hand associated wager area defined on the surface of the gaming table prior to the distribution of the playing card;
b) responsive the receiving of the wager and the distribution of an additional physical playing card to one of the player hand and banker hand, comparing the resulting numerical hand score according to the rules of Baccarat for at least one of the player hand and the banker hand with at least one of a first preset criterion, wherein the first preset criterion is satisfied by the resulting numerical hand score being less than the initial hand score subsequent to the distribution of the additional physical playing card, and a second preset criterion, wherein the second preset criterion is satisfied by the resulting numerical hand score being equal to the initial hand score subsequent to the distribution of the additional physical playing card; and
c) resolving the associated wagering game by one of i) a player win, wherein an award in the form of a physical wagering element having an assigned monetary value is distributed to the participating player responsive to the satisfaction of one of the preset criterion and ii) a player loss, wherein the physical wagering element is removed from the designated area responsive to the failure to satisfy the preset criterion.

10. A method according to claim 9, wherein the amount of the award for satisfaction of the first preset criterion is determined by the resulting numerical hand score.

11. A method according to claim 9, wherein each of the designated player hand associated wager area and the designated banker hand associated wager area further comprise two areas defined on the surface of the gaming table, wherein the two areas include a first wagering area for receiving a wager relating to satisfaction of the first preset criterion and a second wagering area for receiving a wager relating to satisfaction of the second preset criterion.

12. A method according to claim 9, further comprising the steps of:
distributing one or more additional physical playing cards from the group of one or more standard 52-card decks of randomly-ordered physical playing cards to one of a player designated area and a banker designated area on the surface of the gaming table to form one of the final player hand and the final banker hand according to the drawing rules of Baccarat; and
determining the resulting numerical hand score for one of the player hand and the banker hand responsive to the distribution of the physical playing card.
